(19) United States
(12) Patent Application Publication
(10) Pub. No.: US 2010/0122466 A1
(43) Pub. Date: May 20, 2010

(54) ALIGNMENT APPARATUS

(75) Inventors: Jeffrey Hemingway, Burlington, CT (US); Richard R. Picard, West Hartford, CT (US)

Correspondence Address: MCCORMICK, PAULDING & HUBER LLP, CITY PLACE II, 185 ASYLUM STREET, HARTFORD, CT, 06103, US

(73) Assignee: The Wiremold Company, West Hartford, CT (US)

(21) Appl. No.: 12/621,018

(22) Filed: Nov. 18, 2009

Related U.S. Application Data
(60) Provisional application No. 61/116,089, filed on Nov. 19, 2008.

(51) Int. Cl. G01B 11/00; G01C 15/00; G01C 9/00

(52) U.S. Cl. 33/228; 33/286; 33/290

(57) ABSTRACT

An alignment apparatus includes an adapter base having a support for rotatably mounting a laser level device thereon and at least one bracket receptacle adapted to attach to an end of a raceway-mounting bracket or other type of bracket. The adapter base may also include more than one type of bracket receptacle to accommodate different types of brackets.

### FIELD OF THE INVENTION

The present invention relates to an alignment apparatus and, more particularly, to an alignment apparatus for more efficient installation of raceways and surface mount wire covers.

### BACKGROUND OF THE INVENTION

The installation of raceways and other apparatus that require straight-line installation on wall surfaces is a labor-intensive process. Typically, the installer determines an appropriate location for the raceway, attaches a raceway-mounting bracket to a wall, and measures the distance from the bracket to the floor. To ensure level installation of the raceway in both horizontal and vertical dimensions relative to the bracket, the installer next measures the same distance from the floor or wall in multiple locations prior to mounting another raceway-mounting bracket and, finally, mounting the raceway.

This method of installation is disadvantageous for several reasons. As noted above, the process is labor-intensive, which ultimately increases construction costs. Furthermore, this method of installation does not guarantee a perfectly level raceway because floors are not uniformly level. Thus, even measuring in multiple locations will not guarantee a precisely horizontal line. Likewise, if installation of a vertical raceway is desired, the installer would typically take measurements from a wall corner or door frame, which naturally includes variations in size and shape from one end to another and in-between.

Therefore, there exists a need for an improved device and method for installing raceways and other wall- and floor-mounted apparatus requiring level installation.

### SUMMARY OF THE INVENTION

According to the present invention, an alignment apparatus comprises an adapter base having a support for rotatably mounting a laser level device thereon and at least one bracket receptacle adapted to attach to an end of a raceway-mounting bracket or other type of bracket.

Also according to the present invention, another embodiment includes the adapter base having more than one type of bracket receptacle to accommodate different types of brackets.

The foregoing and other advantages of the present invention become more apparent in light of the present invention described in the following detailed description of the exemplary embodiments thereof, as illustrated in the accompanying drawings.

### BRIEF DESCRIPTION OF THE DRAWINGS

FIG. 1 is a perspective view of an alignment apparatus having a laser level device mounted to an adapter base, according to the present invention;

FIG. 2 is a perspective view of the alignment apparatus of FIG. 1 generating a beam line;

FIG. 3 is a bottom view of the adapter base of FIG. 1;

FIG. 4 is a bottom view of the adapter base of FIG. 1 engaging a first bracket;

FIG. 5 is a cross sectional view of the adapter base of FIG. 3 taken along line 5-5;

FIG. 6 is a cross sectional view of the adapter base of FIG. 3 taken along line 6-6;

FIG. 7 is a bottom view of the adapter base of the alignment apparatus of FIG. 1 engaging a second bracket;

FIG. 8 is a bottom view of the adapter base of FIG. 1, including a cover plate;

FIG. 9 is a perspective view of the alignment apparatus of FIG. 1 before engaging the first bracket;

FIG. 10 is a perspective view of the alignment apparatus of FIG. 1 engaging the first bracket showing an activated laser mechanism generating the beam line;

FIG. 11 is a perspective view of the alignment apparatus of FIG. 1 before engaging the second bracket;

FIG. 12 is a perspective view of the alignment apparatus of FIG. 1 engaging the second bracket showing an activated laser mechanism generating the beam line;

FIG. 13 is a top perspective, exploded view of the alignment apparatus according to another embodiment of the invention; and

FIG. 14 is a bottom perspective, exploded view of the alignment apparatus of FIG. 13.

### DETAILED DESCRIPTION OF PREFERRED EMBODIMENTS

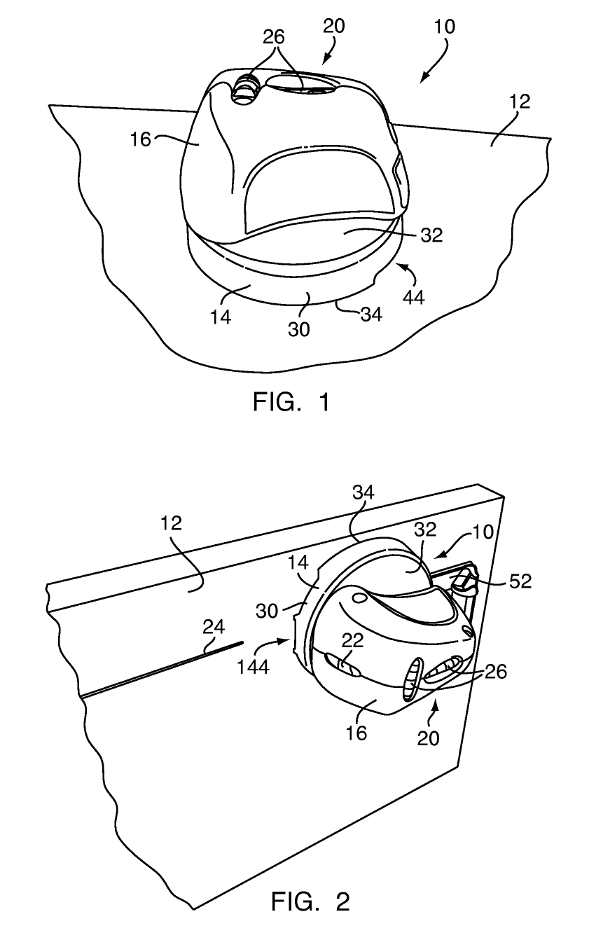

Referring to FIG. 1, an alignment apparatus 10 for mounting on a wall 12 includes an adapter base 14 and a laser level device 16 rotatably mounted thereon. The laser level device 16 is a standard type laser level having a leveling mechanism 20 and a laser mechanism 22 generating a beam line 24, as seen in FIG. 2. Leveling mechanism 20 includes two level indicators 26 set 90 degrees apart to indicate leveling in the horizontal or vertical direction. One type of such laser level device that can be used is manufactured and sold by Strait-Line, a division of Irwin Industrial Tools Company of Ohio, USA under the name of “Strait-Line.” However, any other leveling device may be used.

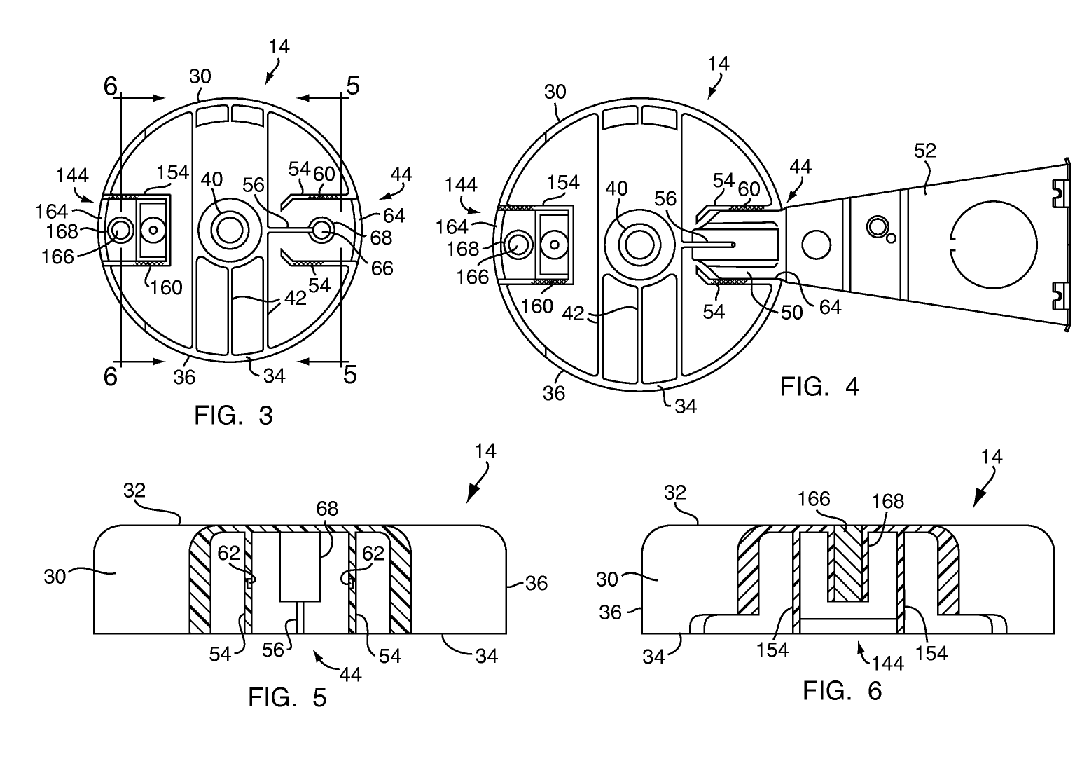

Referring to FIGS. 1 and 3, the adapter base 14 includes a base body 30 having an upper surface 32, a lower surface 34, and a sidewall 36 spanning between the upper surface 32 and the lower surface 34 and extending around a perimeter of the base body 30. The base body 30 also includes a support 40 extending downward from the upper surface 32, to which the laser level device 16 is mounted. Optionally, a plurality of stiffeners 42 may extend across the base body 30 for providing structural rigidity thereto.

Referring to FIGS. 3, 4, and 5, the adapter base 14 may include a bracket receptacle 44, the configuration of which is adapted to mate with and support a bracket end 50 of a bracket 52. The bracket receptacle 44 includes two ribs 54 and a central flange 56 extending radially outward from stiffeners 42. The ribs 54 and central flange 56 cooperate to define a shape of the bracket receptacle 44 to mate with a geometry of the bracket end 50. The ribs 54 may include friction-generating elements 60 to generate friction against the wall 12 and additional features, such as grooves 62, which allow engagement between the bracket receptacle 44 and the bracket end 50. The bracket receptacle 44 also includes a cutout 64 of the sidewall 36. Cutout 64 extends along a perimeter of the base body 30 and is dimensioned to accommodate a width and height of the bracket end 50. Optionally, the bracket receptacle 44 may also include a magnet 66 disposed in a boss 68, which strengthens the attachment of the bracket receptacle 44 to the bracket end 50. However, it will be appreciated that the magnet 66 could be secured to the bracket receptacle 44 by any known means such as glue or bonding.

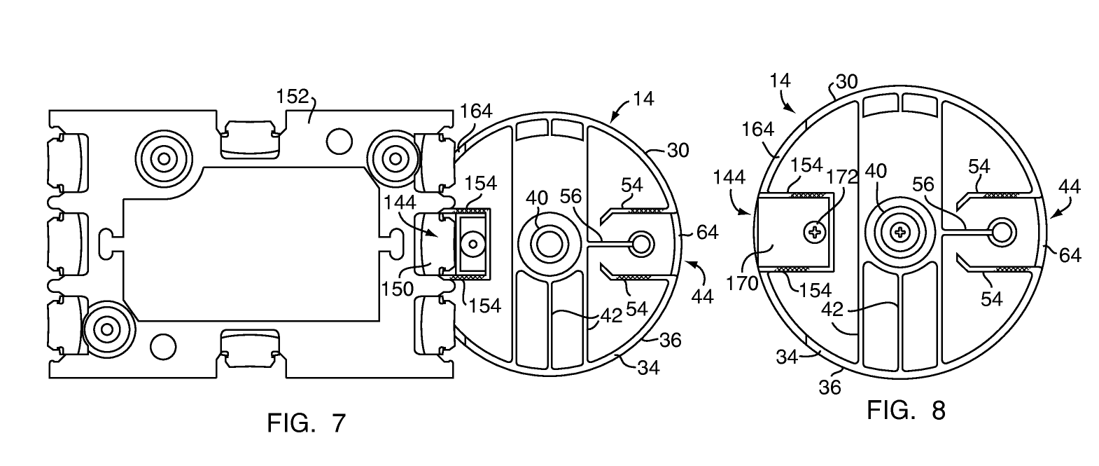

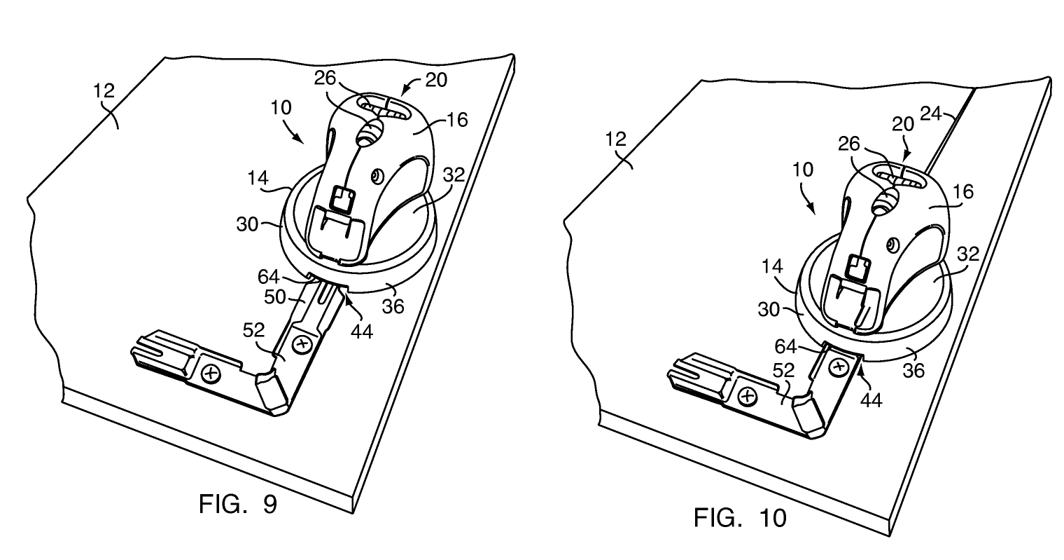

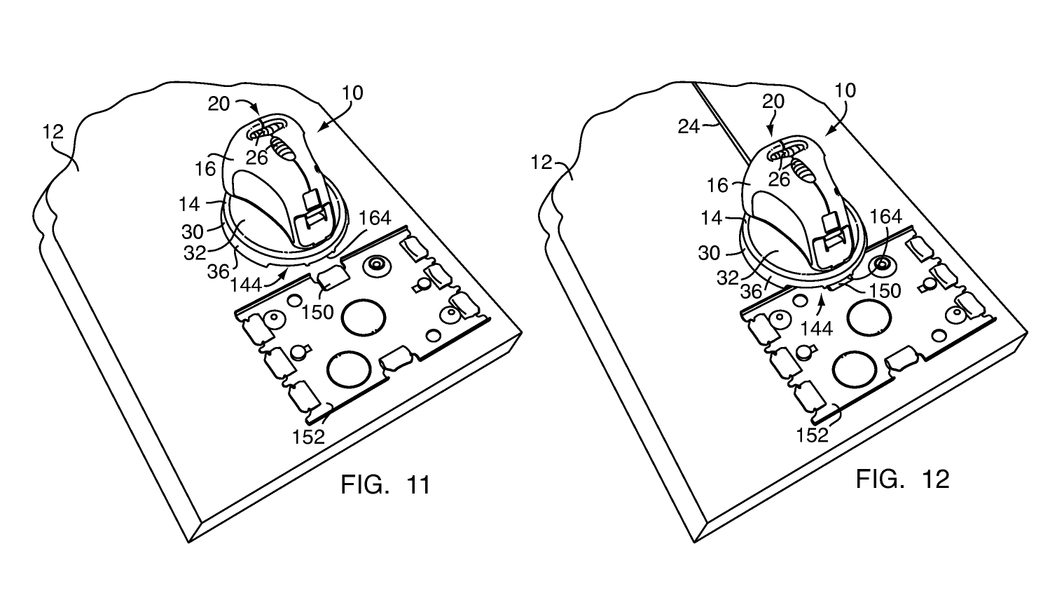

Referring to FIGS. 3, 6, and 7, the present invention may also include a second bracket receptacle 144, the configuration of which is adapted to mate with and support a second bracket end 150 of a second bracket 152. The bracket receptacle 144 includes a plurality of ribs 154, which cooperate to define a geometry that is complementary to a geometry of the bracket end 150, shown in FIG. 7. The ribs 154 may include friction-generating elements 160 to generate friction against the wall 12. The bracket receptacle 144 also includes a cutout 164 of the sidewall 36. Cutout 164 extends along a perimeter of the base body 30 and is dimensioned to accommodate a width and height of the bracket end 150. Optionally, the bracket receptacle 144 may also include a magnet 166 disposed in a boss 168, which further secures attachment of the bracket receptacle 144 to the bracket end 150. However, it will be appreciated that the magnet 166 could be secure to the bracket receptacle 144 by any known means such as glue or bonding. Optionally, as shown in FIG. 8, the bracket receptacle 144 may also include a cover plate 170 attached to the adapter base 14 by a fastener 172 to allow more secure engagement between the bracket receptacle 144 and the bracket end 150.

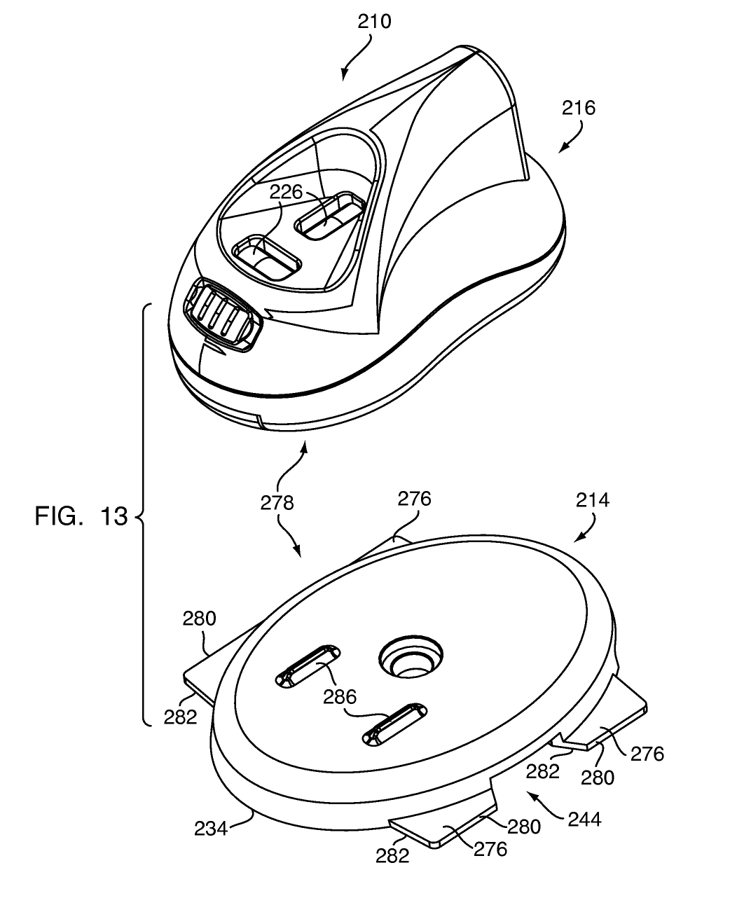

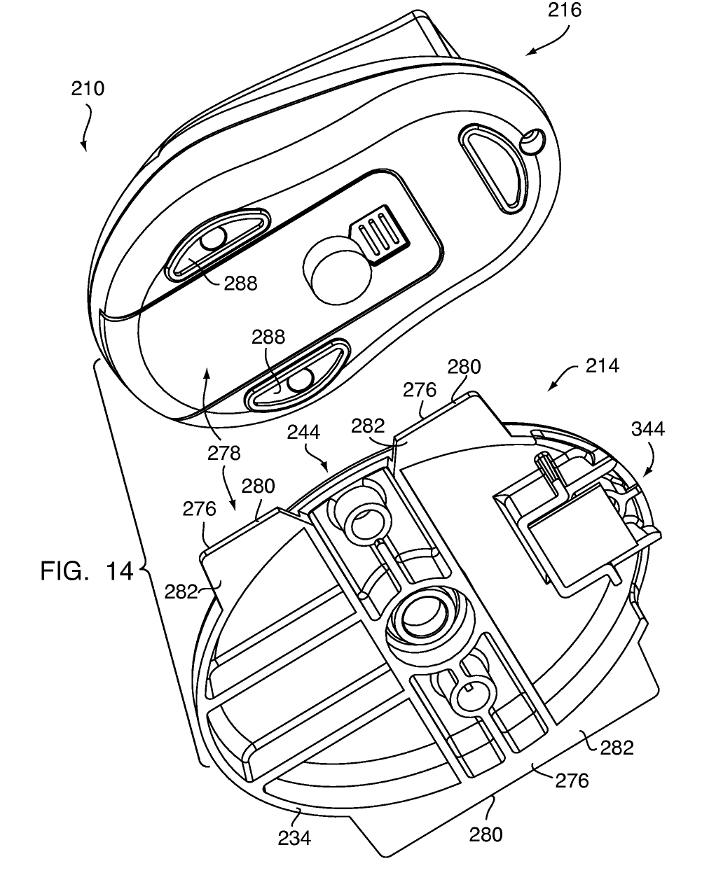

Referring to FIGS. 13 and 14, in another embodiment of the invention, wherein the like numerals represent the like elements, an alignment apparatus 210 includes wings 276 extending from the adapter base 214 and a locking mechanism 278. The wings 276 include an edge 280 and a wings bottom surface 282 that is substantially flat and flush with the lower surface 234 of the adapter base 214. The locking mechanism 278 includes adapter base protrusions 286, best seen in FIG. 13, and level indents 288, best seen in FIG. 14. The protrusions 286 and indents 288 mate to lock the alignment apparatus 210 in a locking position such that the laser level device 216 is locked with respect to the adapter base 214 in a position so that one of the level indicators 226 of the laser level device 216 is level with respect to the edge 280. Although the adapter base protrusions 286 are shown as being substantially parallel to the edge 280, the position of the protrusions 286 and indents 288 is not limited to the embodiment shown. Rather, the locking mechanism 278 may be any type of mechanism as long as its mating condition locks the laser level device 216 in a position parallel with respect to the edge 280. Additionally, the adapter base 214 includes a bracket receptacle 244 and a second bracket receptacle 344 disposed substantially 90° offset from each other so as to not to interfere with the locking mechanism 278.

In operation, the operator pre-assembles the alignment apparatus 10 by mounting the laser level device 16 upon the support 40 of the adapter base 14. Once the bracket 52 is mounted onto the wall 12 at any desired location, as shown in FIG. 9, the bracket receptacle 44 is aligned with the bracket end 50. As the alignment apparatus 10 is brought into contact with the bracket 52, as shown in FIG. 10, the grooves 62 of the bracket receptacle 44 receive the edges of the bracket end 50 as the bracket receptacle 44 mates with and attaches to the bracket end 50. The ribs 54 and central notch 56 of the bracket receptacle 44 ensure that the alignment apparatus 10 attaches to the bracket 52 securely and without play for proper alignment. To increase cohesion between the bracket receptacle 44 and the bracket end 50, the magnet 66 attracts the bracket end 50. The friction generating elements 60 ensure that the alignment apparatus 10 does not slip against the wall 12.

When the alignment apparatus is to be used with bracket 152, bracket 152 is mounted to the wall 12 and the alignment apparatus 10 is brought into engagement with the bracket 152 by inserting the bracket end 150 between the cover plate 170 and the adapter base 14, as shown in FIG. 12. The magnet 166 attracts the bracket end 150 to increase cohesion between the bracket receptacle 144 and the bracket end 150.

Once the alignment apparatus 10 is attached to either bracket 52 or 152, as shown in FIGS. 10 and 12, the laser level device 16 is rotated relative to the adapter base 14 until the level indicator 26 of the leveling mechanism 20 indicates that the alignment apparatus 10 is level in a horizontal direction. Once the desired leveling is achieved, the laser mechanism 22 is activated to generate the beam line 24, which indicates a straight line on the wall 12, as shown in FIGS. 10 and 12. The beam line 24 is used to mark a level location for the subsequent mounting of a second bracket of like type. The pair of brackets may ultimately support a raceway or any other type of device requiring level installation, such as a shelf. If vertical alignment with bracket 52 or 152 is desired, the laser level device 16 can be rotated 90° with respect to the base so that the leveling and mounting in the vertical direction can be also performed without disengaging the adapter base 14 from the bracket 52.

The locking mechanism 278 and the edge 280 cooperate to allow the alignment apparatus 210 to function as a level. The laser level device 216 is rotated until the adapter base protrusions 286 and level indents 288 mate into a locking position. Once in the locking position, the edge 280 can be lined up to any item to insure that it is plumb. Thus, an installer of the raceway, can lock the alignment apparatus 210 and insure that the electrical box, for example, is mounted properly on the wall. Upon completion of using the alignment apparatus 210 as a level, the laser level device 216 is rotated with respect to the adapter base 214 so that the alignment apparatus 210 can be used for installation of raceways or other items. In the embodiments shown in FIGS. 13 and 14, the bracket receptacles 244, 344 are disposed 90° apart to avoid interference with the locking mechanism 278. Thus, once the alignment apparatus 210 is moved from the locking position, and rotated 180° therefrom, it is not restrained and can be easily rotated to allow fine-tuning for leveling with respect to the bracket (not shown in this FIG.).

One advantage of the present invention is that the alignment apparatus 10 simplifies and significantly improves the installation process of raceways. In particular, the alignment apparatus 10 of the present invention allows installation of raceways without the need for measuring and marking the wall in multiple locations.

Another advantage of the present invention is that the alignment apparatus 10 allows for superior accuracy and reliability in the installation of raceway systems. For example, relying on a floor for a baseline measurement for drawing a line parallel to the floor at a pre-determined distance therefrom is not accurate due to imperfections and dips in flooring.

Yet another advantage of the present invention is that the alignment apparatus 10 allows for alignment and positioning of raceways in two dimensions relative to the brackets. The laser level device 16 can be rotated and adjusted to generate beam lines in both horizontal and vertical directions with minimal effort from the operator because the laser level device 16 includes level indicators 26 for both the horizontal and vertical directions and is rotatably mounted on the adapter base 14.

A further advantage of the present invention is that the alignment apparatus 10 allows for installation of not only raceway systems or apparatus, but also installation of any system or apparatus requiring a horizontal or vertical line, such as shelving systems or even large wall hangings. More specifically, the configuration of structural features such as ribs, notches, grooves, and cutouts of the bracket receptacles can be adjusted to accommodate brackets for any type of industry.

An advantage of the locking mechanism 278 and the edge 280 is that it allows the alignment apparatus 210 to function as a regular leveling mechanism. Moreover, the wings 276 add further stability to the alignment apparatus 210.

Although this invention has been shown and described with respect to the detailed embodiments thereof, it will be understood by those skilled in the art that various changes in form and detail thereof may be made without departing from the spirit and the scope of the invention. For example, although the Figures show the adapter base 14 having two bracket receptacles, one, three, four or another number of receptacles can be formed in the adapter base 14. Moreover, while bracket receptacle 44 and 144 have been defined by certain structural features such as ribs, notches, grooves and cutouts, it will be appreciated that any structural elements may be employed in the base body 30 to form a bracket receptacle having a shape complementary to the geometrical elements of any bracket. In particular, while bracket receptacles 44 and 144 are adapted to mate with brackets 52 and 152, respectively, which are commonly used in the raceway industry, it will be appreciated that the bracket receptacles of the present invention can be modified to accommodate brackets used for mounting shelving units or home electronics equipment, or for any other application. Furthermore, the alignment apparatus 10 can be used with a plurality of adapter bases. For example, the laser level device 16 can be detached and be placed onto various adapter bases with each of the adapter bases having multiple bracket receptacles adapted to engage with multiple types of brackets. Thus, the interchangeable adapter bases would allow use of the alignment apparatus 10 in various industries. Although the edge 280 is shown to be extending from the adapter base 214 in FIGS. 13 and 14, the edge 280 can be formed integrally with the base 214. For example, the base 214 can have a square or rectangular shape, thus, incorporating the edge 280 therein.

What is claimed is:

1. An alignment apparatus comprising:
a laser level device; and
an adapter base for mounting the laser level device thereon, wherein the adapter base comprises a base body and at least one bracket receptacle adapted to receive a bracket end of a bracket.

2. The alignment apparatus of claim 1, wherein the adapter base comprises a support for rotatably mounting the laser device thereon.

3. The alignment apparatus of claim 1, wherein the laser level device comprises a level mechanism and a laser generating mechanism and he laser generating mechanism generates a beam line upon activation.

4. The alignment apparatus of claim 3, wherein the laser level device rotates relative to the adapter base to generate the beam line in multiple directions relative to the adapter base.

5. The alignment apparatus of claim 1, wherein the at least one bracket receptacle includes features to mate with the bracket end.

6. The alignment apparatus of claim 5, wherein said features comprise ribs.

7. The alignment apparatus of claim 6, wherein said ribs comprise grooves adapted to engage edges of the bracket end.

8. The alignment apparatus of claim 1, wherein the adapter base comprises a plurality of bracket receptacles.

9. The alignment apparatus of claim 1, wherein the base body comprises a plurality of stiffeners disposed across a lower surface of the base body.

10. The alignment apparatus of claim 1, comprising a cover plate adapted to be secured to the at least one bracket receptacle to support the bracket end.

11. The alignment apparatus of claim 1, wherein the laser level device and the adapter base are detachable.

12. The alignment apparatus of claim 1, wherein the at least one bracket receptacle comprises a magnet for attracting the bracket end.

13. A device for an alignment apparatus comprising:
an adapter base comprising a base body for rotatably supporting a laser level device thereon,
wherein the base body comprises at least one bracket receptacle adapted to receive a bracket end of a bracket, and
wherein the at least one bracket receptacle comprises features to mate with the bracket end.

14. The device of claim 13, wherein said features comprise ribs.

15. The device of claim 14, wherein said ribs comprise grooves adapted to engage edges of the bracket end.

16. The device of claim 13, wherein said features comprise a cutout to accommodate the geometry of the bracket end.

17. The device of claim 13, wherein the at least one bracket receptacle comprises a magnet.

18. The device of claim 13, wherein the base body comprises a first bracket receptacle adapted to receive a first bracket end of a first bracket and a second bracket receptacle adapted to receive a second bracket end of a second bracket and wherein the first bracket end and second bracket end are dissimilar.

19. The device of claim 13, wherein the base body comprises a plurality of bracket receptacles adapted to receive a plurality of bracket ends of brackets and wherein the bracket ends are dissimilar.

20. A method for installing a raceway comprising:
mounting a first bracket on a wall;
providing an adapter base with a laser level device mounted thereon, the adapter base having at least one bracket receptacle and the laser level device having a leveling mechanism and a laser generating mechanism;
engaging the at least one bracket receptacle with the first bracket mounted on the wall;
adjusting the laser level device such that the leveling mechanism indicates leveling; and
activating the laser mechanism to generate a first beam line on the wall.

21. The method of claim 20, further comprising steps of:
mounting a second raceway bracket on a point along the first beam after generating said first beam line; and
installing a raceway on the first raceway bracket and the second raceway bracket.

22. The method of claim 20, further comprising a step of rotating the laser level device relative to the adapter base after generating said first beam line and generating a second beam line.

23. The alignment apparatus according to claim 1 further comprising:
an edge formed on the adapter base; and
a locking mechanism for locking the laser level device with respect to the adapter base to allow the alignment apparatus to be used as a level.

24. The alignment apparatus of claim 23 wherein the locking mechanism includes at least one mating protrusion and at least one mating indent to allow locking of the laser level device to the adapter base.
